(19) United States
(12) Patent Application Publication
(10) Pub. No.: US 2004/0103122 A1
(43) Pub. Date: May 27, 2004

(54) Method and system for filtered web browsing in a multi-level monitored and filtered system

(76) Inventors: John Irving, Ottowa (CA); Marcello Bursztein, Ottowa (CA); Steve Mulligan, Ottowa (CA); Patrick Lajeunesse, Ottowa (CA)

Correspondence Address: JAMES D. FORNARI ESQ, SUITE 3-A, 1020 PARK AVENUE, NEW YORK, NY, 10028, US

(21) Appl. No.: 10/619,099

(22) Filed: Jul. 14, 2003

Related U.S. Application Data
(60) Provisional application No. 60/395,410, filed on Jul. 13, 2002.

(51) Int. Cl. G06F 17/30

(52) U.S. Cl. 707/200

(57) ABSTRACT

The present invention is a method and system for integrating a browser into and making it a part of a monitored and filtered data transmission system for a school or other controlled environment. A browser is configured by an administrator to require that all pages be reviewed and checked before they are delivered to the recipient. The browser directs that the monitoring and filtering applicable to the hierarchical system be exercised with regard to the pages to be reviewed. The system also contains a hierarchical control level so that varying filtering and monitoring control is available at each level of the hierarchy and can be configured down to the individual user level to permit the overall system to remain secure while providing appropriate browser capabilities to the users, be they student, teachers, administrators or parents. The administrator or other control person within the hierarchy can also prevent access to any other browser, making the filtered browser the only one available to the user.

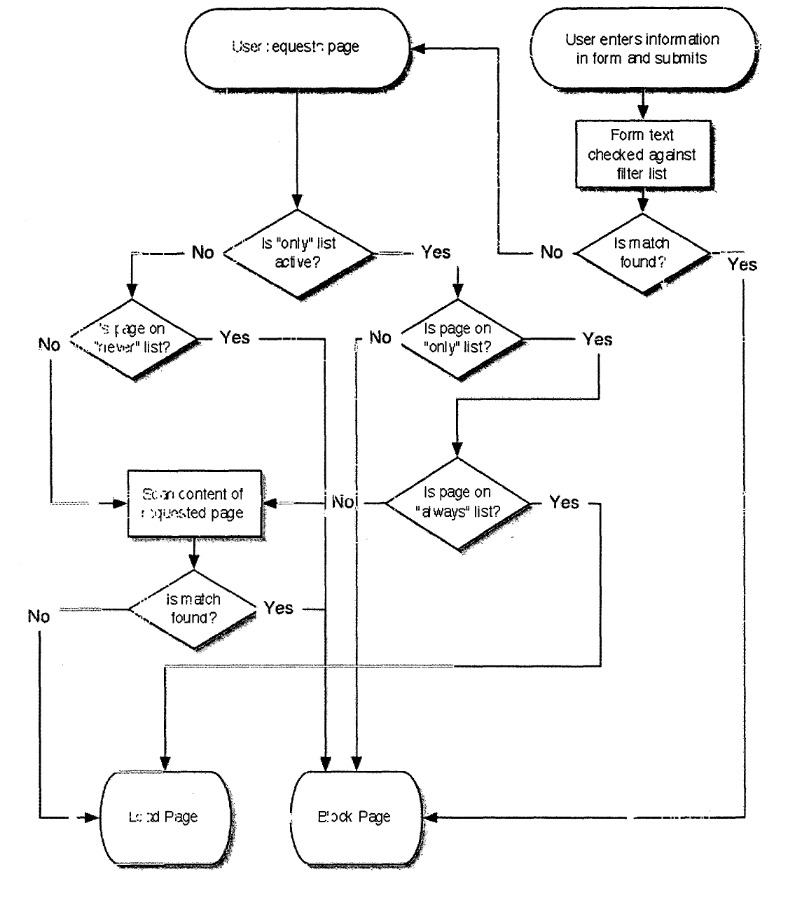

### BACKGROUND OF THE INVENTION

The Internet has permitted information flow to be delivered to students in hitherto unimaginable quantities. The quality of information, however, is not uniform. Some information comes with the imprimatur of recognized providers, such as Scholastic, or publishers, such as Random House and Harper Collins. Still other information can come from recognized institutions such as Woods Hole Oceanographic Institute or from university media centers, where it has been reviewed and internally monitored for content.

Schools today are charged with the dual tasks of providing access to the Internet while concomitantly providing a safe and secure learning environment for the students. Filtering e-mails is one important step in the creation of a school district (or business environment) with secure “virtual classrooms”, “virtual student/teacher conference centers” and “virtual group sites”. With filtering comes the need to monitor the transmissions. It is vital that an enterprise, be it a school or a business, be able to have its constituent parts communicate with one another in real time, provide information and obtain flow both internally and from without, be secure and provide a level of filtering and monitoring consistent with the objectives of the enterprise. In the case of a school district, it is important that the schools have access to information, be able to access a “classroom” community for “share learning” and provide a level on filtering and monitoring consistent with the particular requirement of a given class or group of students. At the same time, intra-class and intra-school communication is necessary to permit the rapid dissemination of information, whether time sensitive or recipient sensitive, in an efficient manner.

One system that provides a universal solution to allowing information flow to both students and educators, while maintaining control of the type and character of material received by students is described in Provisional Patent No: ______. It permits internal community or group generation to permit dissemination of information to different levels of educators or administrators on a needs basis. The system can employ common server capability to permit multiple districts to have their individual SchoolMail, while at the same time providing the capability of interaction and connectivity among the districts, based upon screening and search criteria. The system can provide filtering and monitoring for both incoming and outgoing data transmissions on multiple levels, such as class specific, school specific and district or region specific. It can also control the desktop of the personal computers that on the SchoolMail system to prevent students from getting off and onto an open and uncontrolled system.

The hierarchy within that system was created to permit the easy management of every aspect of the SchoolMail system:

Systems administrators

Reseller administrators

District administrators

School administrators

Monitors

Students

Every level of the hierarchy can control the levels below. When new accounts are created, they inherit the attributes of the levels above. Within each level, there can be multiple sub-levels with attributes of levels both above and below, depending on the person who is responsible for creating the account.

However, without the ability to filter web access, filtered e-mail alone, while vital and necessary for a school system, cannot fully satisfy all of the security requirements of a school. If a student can circumvent the system by going on to another site offering web-based e-mail, then the filtering and monitoring relied upon to provide security is hampered. Although a school can implement a proxy server-based solution such as Bess or a client-based solution such as CyberSitter to block access to particular websites, students can circumvent those solutions and surf for unblocked sites to provide unfiltered and unmonitored e-mail access. In order to complete the security of a school system, a client based solution should be implemented and configured from an administrator's interface which will allow the administrator, or their designee, to allow access settings to be applied to an individual user upon log-in. A filtered web browser which blocks sites commencing with the first page and any below that in the site's hierarchy fills the need for school security and prevents circumvention of the monitoring and filtering systems which permit controlled “virtual classrooms” and collaborative, shared learning.

### DESCRIPTION OF THE METHOD AND SYSTEM

The browser can be integrated and made a part of a filtering and monitoring system for a school or other controlled environment. Because of the hierarchical nature of the filtering and monitoring system, an administrator can configure the browser to require that it checks all pages before they are delivered. The administrator can also configure the system so as to prevent access to any other browser, making the filtered browser the only one available to the users. Because the filtering and monitoring system has varying levels of control available at each level of the hierarchy and can be configured down to the individual user level, it permits the overall system to remain secure, while still providing appropriate browser capabilities to the users, be they students or teachers.

Administration

The administration of the system has both central component and user components that can be handled by the principle administrator or delegated to others within the hierarchy. These can be adjusted so that there can be a greater or lesser administrative function for each component, depending on the desires of the user and the requirements for security inherent in the system.

Checking/Adding Words

This interface allows the administrator to view the current filtered word lists, and add or remove words as desired. The administrator can also enter a word into a search field to see if the word would be filtered as written. Enter Word

If a word on the Master Flagged Word List is found, the user is given the option to unflag it in the browser. Similarly, if word is not found, a user can add it as partial or whole for both features.

Administrative Interface

Browser Settings Page

Browser settings can easily be applied to individuals or groups of users, or an entire school or district at once.

Block Sites Interface

Text area where uniform resource locators (URLs) can be entered. Pages will be blocked at or below the URL entered—if the top level domain of a website is entered, all pages in that site will be blocked.

Customized Keywords

Allow administrators to add/exclude words on the keyword list.

Allow Pop-Ups

One feature that the administrator can activate prevents some sites from pushing ads.

Content Filtering

This switch can turn filtering on or off for the selected user or users. For example, administrators may want to turn filtering off altogether for staff

System Blocking

Allow any application to launch, but only allow the browser to have Internet access

Block everything that is not the browser, hide start menu, block ctrl-alt-del. functions from the keyboard

Or off altogether

Address Bar Show/Hide

Prevents manual entry of URLS.

Allow https

Can prevent access to shopping sites.

Adding Sites to Always Allow/Never Allow Lists through Browser

In addition to using the administration interfaces, users with administration privileges can have additional features, such as two additional buttons, available when they log in through the browser. These buttons allow them to instantly mark a page either to be always allowed or never blocked. Doing so adds the currently viewed site to the appropriate list.

### EXAMPLE APPLICATIONS

### Example 1

### Page Blocking

Pages are checked against all of the below before being displayed to the user. If it is to be blocked, the user sees a dialogue explaining that the page is blocked. Text for the dialogue can be configurable on both host and the user level. Each of these can be turned on or off for an entire license, school, or any other group of or individual users.

Only Allow Site List

Can be used to restrict access to a small group of known sites.

Sites on this list will still be scanned for content unless they also appear on the Always Allow list.

Always Allow Site List

Sites on this list will always be displayed—content scanning will not take place.

Never Allow Site List

Sites on this list will always be blocked—content scanning will not take place.

Keyword Scan of the Site's Textual Content

Page content is compared against a list of keywords. If words from the list are found on the page the page is blocked.

Scanning Form Input

When users type information into a form (such as a search engine), the browser scans the input before it is submitted. This can effectively stop users from searching for sites that may contain questionable content, even before they attempt to load them.

Disallowing Manual URL Entry/Hide Addressbar

If active, the browser will not accept entered URLs. This prevents the browser being used to visit sites other than those linked to in currently visible pages. This allows an administrator to create a limited access to the Internet by controlling the links on pages accessible to users.

### Example 2

### Auto-Update

The browser can be required to check for updates on hosting server every time it is run (or some set interval), and automatically install updates the next time the browser is launched.

### Example 3

### SchoolMail Database Integration

When launching the browser, the user must login using a dialog within the application. The user is logged in on the hosting server and the user's personal settings are pulled from the database. A default set of behaviors for the browser may be used in the case of users entering nothing or ‘guest’. This behavior could range from no access to access only to the hosting website, to full access with filtering. The default behaviors will be applied to the application itself, and would only change if the hosting server or the administrator pushed the update to the user.

Settings are applicable on a user basis, with administration interfaces within the monitoring and filtering system, allowing the administrators to assign settings to groups or individual users.

### Example 4

### Customized Look and Feel

The host can design an interface which will allow customized interface elements based on user preferences.

### Example 5

### Bookmarks Stored on Server

It is a further advantage to permit bookmarks to ‘follow’ the user, making them always accessible regardless of the computer used. In addition, the district will maintain a list of bookmarks that are always available and can be edited by administrators. The host can also maintain its own list of bookmarks that will be pushed to every user regardless of other settings.

### Example 6

### History Purged after Each Session

In order to avoid excess storage use, the history will not stay with the user unless specified, so each user will start fresh when they login to the browser.

### Example 7

### Multilingual Keywords

The system will allow the browser to scan and block sites in languages other than English (including full double-byte language support).

### Example 8

### Categorized Keywords

The system can categorize keywords so that entire categories could be turned on or off. For example, sexual content, violence, racism, ecommerce etc.

### Example 9

### Levels of Filtering

The system can operate in a manner similar to categorization above to allow administrators to define levels of blocking that might be appropriate to certain groups. Teachers, high school, middle school, and elementary can have different basic levels appropriate to them. These levels would work based on the types of keywords blocked.

### Example 10

### Localized Interface

The system can incorporate a simultaneous translation function including an Application Program Interface to permit all interface elements translated so the browser is accessible in all languages, with the correct language being displayed based on the user.

### Example 11

### Customized Look and Feel Based on Administrator and User Criteria

The system will permit the customization of buttons, icons, colors, dialogues, menus etc. based on the administrator and user criteria. Elementary school children can be given access through a simple interface, while high school students can have a more complex and rich interface.

### Example 12

### Usage Log

The system can be adapted to log every page/site visited by each user, allowing administrators to view reports of browsing habits of their users. This will permit additional monitoring. For example, if there is substantial late night browsing of otherwise benign-looking sites, it may raise a flag as to the nature of the sites.

### Example 13

### Time Usage Restrictions

In an effort to further limit the improper use of the system, the browser could be allowed to run only at particular times or for a certain amount of time per user.

### Example 14

### Threshold Filtering

The system can be instructed to check pages for how often keywords appear to better determine whether it's likely to be a safe page or not.

We claim:

1. An apparatus for integrating a browser into and making it a part of a monitored and filtered data transmission to screen unwanted material comprising a browser means configured to require that substantially all pages be reviewed and checked before delivery to the recipient, said browser means creating varying degrees of accessibility to data in accordance with predetermined limits and criteria and being dynamically controlled to prevent the use of any other browser in conjunction with the system, a dynamic search engine to permit searching of data, a dynamic filter controlled by a central location to permit monitoring and filtering of the data transmitted and structuring of the infrastructure and a flagging filter component to scan messages and data prior to delivery.
